(19) United States
(12) Patent Application Publication
(10) Pub. No.: US 2019/0091908 A1
(43) Pub. Date: Mar. 28, 2019

(54) PROCESS FOR MAKING A PROTECTIVE SHELL UNIT FOR A HANDHELD ELECTRONIC DEVICE AND THE PROTECTIVE SHELL UNIT MADE THEREBY

(71) Applicant: PIONEER MATERIAL PRECISION TECH CO. LTD., New Taipei City (TW)

(72) Inventors: Te-Ning CHEN, New Taipei City (TW); Jung-Hua SHEN, New Taipei City (TW)

(21) Appl. No.: 15/868,388

(22) Filed: Jan. 11, 2018

(30) Foreign Application Priority Data
Sep. 28, 2017 (TW) 106133305

(51) Int. Cl. B29C 45/16; B29C 45/00

(52) U.S. Cl. CPC B29C 45/1679; B29K 2083/00; B29C 45/0001

(57) ABSTRACT

A process for making a protective shell unit for a handheld electronic device comprises steps of: a) injection molding a blend of a first plastic material and a phosphorescent pigment in a first mold cavity which defines a switch button portion-forming region to obtain a switch button portion; and b) injection molding a second plastic material in a second mold cavity which defines a shell body-forming region to integrally form a shell body with the switch button portion so as to obtain an integral shell.

### CROSS-REFERENCE TO RELATED APPLICATION

This application claims priority of Taiwanese Application No. 106133305, filed on Sep. 28, 2017.

### FIELD

The disclosure relates to a process for making a protective shell unit, and more particularly to a process for making a protective shell unit for a handheld electronic device. The disclosure also relates to a protective shell unit for a handheld electronic device made by the process.

### BACKGROUND

A protective shell for a handheld electronic device (for example, a mobile phone) may be provided with a fluorescent visual effect. A method generally employed in the existing art is to directly mold a protective shell using a material containing a fluorescent dye such that the entire protective shell is luminous or glows in the dark. An alternative method is printing or coating one or more selected areas of a protective shell with a fluorescent material (for example, a clear paint containing a phosphorescent pigment) so as to form a fluorescent pattern at the one or more selected areas of the protective shell.

However, the manner of forming the protective shell by directly molding the material containing the fluorescent dye requires use of a large amount of the fluorescent dye and may not provide the fluorescent visual effect specifically at one or more desirable areas of the protective shell. As for the latter method, the fluorescent pattern formed on the one or more selected areas (for example, a switch button area and the like) of the protective shell by printing or coating may wear off after a period of use due to contact or scratching.

### SUMMARY

An object of the disclosure is to provide a process for making a protective shell unit for a handheld electronic device to overcome the aforesaid shortcomings of the existing art.

According to a first aspect of the disclosure, there is provided a process for making a protective shell unit for a handheld electronic device. The protective shell unit includes a shell body and a switch button portion. The shell body includes a back wall having two marginal edges opposite to each other in a transverse direction, and two minor sidewalls respectively extending forwardly from the two marginal edges. The switch button portion is disposed in one of the two minor sidewalls. The process comprises steps of:

a) injection molding a blend of a first plastic material and a phosphorescent pigment in a first mold cavity which defines a switch button portion-forming region to obtain the switch button portion; and

b) injection molding a second plastic material in a second mold cavity which defines a shell body-forming region to integrally form the shell body with the switch button portion so as to obtain an integral shell.

According to a second aspect of the disclosure, there is provided a protective shell unit for a handheld electronic device made by the process according to the first aspect of the disclosure.

### BRIEF DESCRIPTION OF THE DRAWINGS

Other features and advantages of the disclosure will become apparent in the following detailed description of the embodiment(s) with reference to the accompanying drawings, of which:

FIG. 1 is a schematic sectional view showing consecutive steps of an embodiment of a process for making a protective shell unit for a handheld electronic device according to the disclosure;

FIG. 2 is a flow diagram of the embodiment; and

FIG. 3 is an exploded perspective view of a protective shell unit for a handheld electronic device made according to the embodiment.

### DETAILED DESCRIPTION

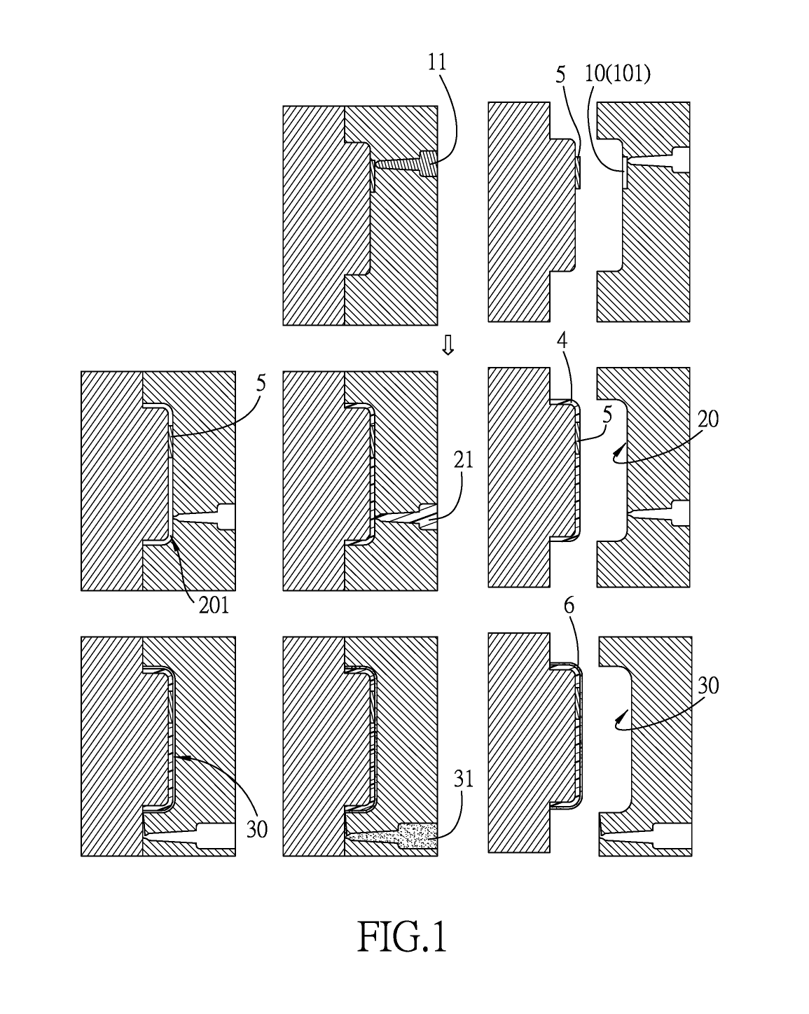

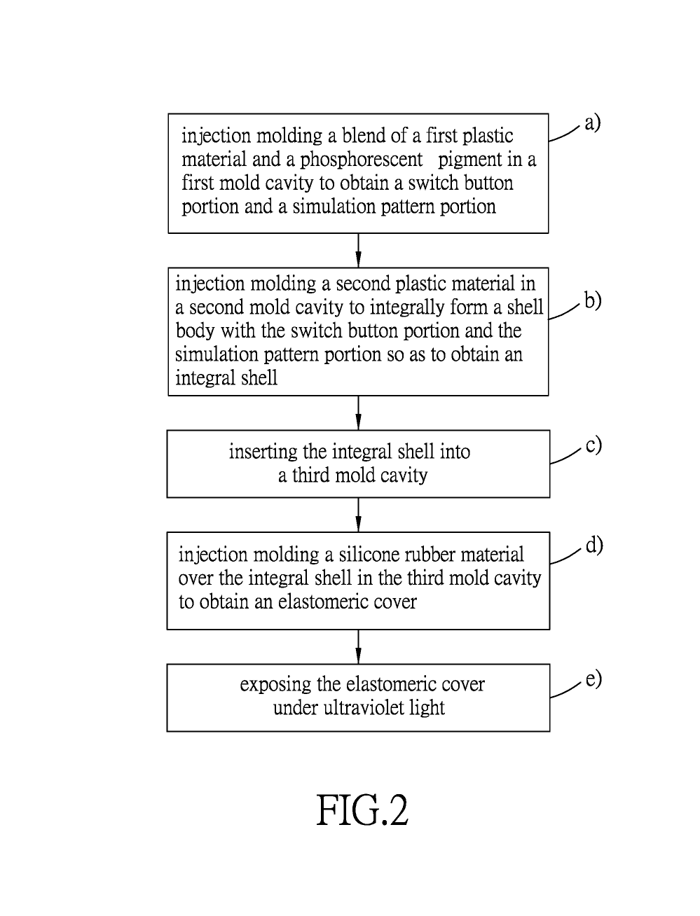

FIGS. 1, 2, and 3 show an embodiment of a process for making a protective shell unit for a handheld electronic device according to the disclosure.

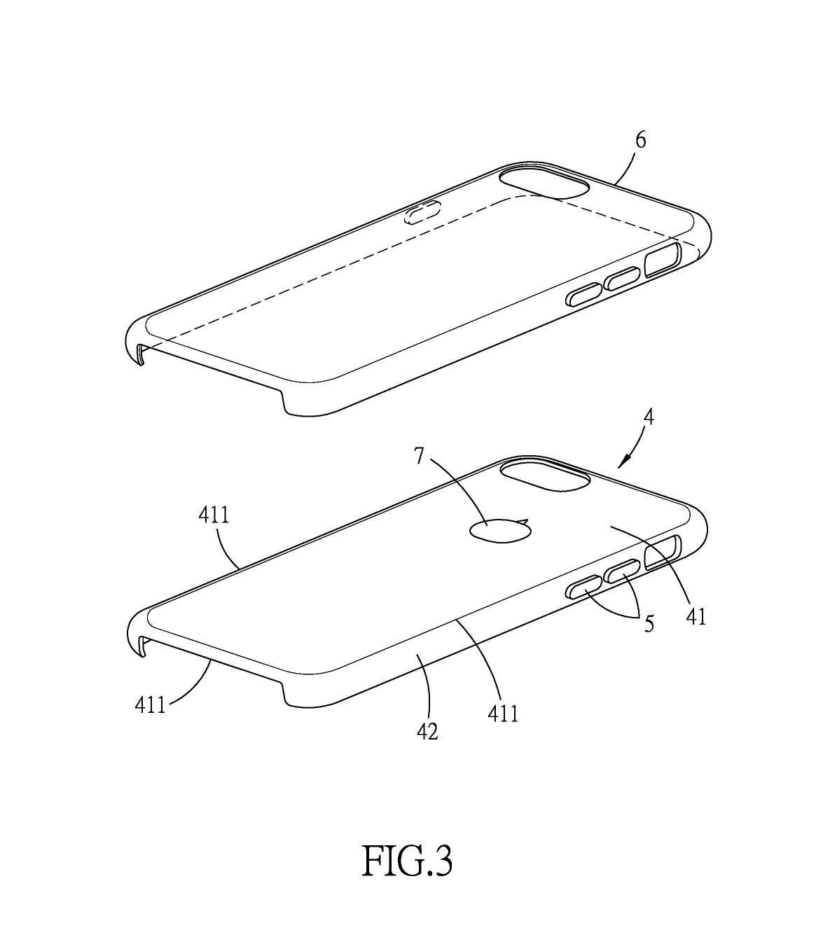

Specifically referring to FIG. 3, the protective shell unit is shown to include a shell body 4, a switch button portion 5, and a simulation pattern portion 7 (for example, a portion simulating a logo on a mobile phone). The shell body 4 includes a back wall 41 having two marginal edges 411 opposite to each other in a transverse direction, and two minor sidewalls 42 respectively extending forwardly from the two marginal edges 411. The switch button portion 5 is disposed in one of the two minor sidewalls 42. The simulation pattern portion 7 is disposed in the back wall 41.

The embodiment of the process according to the disclosure comprises steps of:

a) injection molding a blend 11 of a first plastic material and a phosphorescent pigment in a first mold cavity 10 which defines a switch button portion-forming region 101 and a simulation pattern portion-forming region (not shown) to obtain the switch button portion 5 and the simulation pattern portion 7;

b) injection molding a second plastic material 21 in a second mold cavity 20 which defines a shell body-forming region (201) to integrally form the shell body 4 with the switch button portion 5 and the simulation pattern portion 7 (not shown in FIG. 1) so as to obtain an integral shell;

c) inserting the integral shell into a third mold cavity 30;

d) injection molding a silicone rubber material 31 over the integral shell in the third mold cavity 30 to obtain an elastomeric cover 6 which simulates a contour of the integral shell; and

e) exposing the elastomeric cover under ultraviolet light.

Examples of the first plastic material used in step a) include, but are not limited to, polycarbonate, polyethylene, polypropylene, polystyrene, polyurethane, and combinations thereof. In some embodiments, polycarbonate is used as the first plastic material. A commercial example of polycarbonate is PC1000, a polycarbonate resin commercially available from SABIC. A commercial example of the phosphorescent pigment is Phosphorescence Pigment #6001C (yellow green color) commercially available from New Particle Chemical Colors Co. A non-limiting example of the blend 11 may be prepared by blending PC1000 with #6001C in a weight ratio of 100:3.

Step a) is performed at a temperature ranging from 70° C. to 110° C.

Examples of the second plastic material used in step b) include, but are not limited to, polycarbonate, polyethylene, polypropylene, polystyrene, polyurethane, and combinations thereof. The second plastic material may be the same as or different from the first plastic material. In some embodiments, polycarbonate is used as the second plastic material. A commercial example of polycarbonate is PC1000.

Step b) is performed at a temperature ranging from 70° C. to 110° C.

Step d) is performed at a temperature ranging from 110° C. to 130° C. A commercial example of the silicone rubber material 31 is self-adhesive liquid silicone rubber (LR 3077 commercially available from Wacker Chemie AG).

In some embodiments, a further step of applying a primer layer onto the integral shell may be performed between step c) and step d) such that the primer layer is formed between the integral shell and the elastomeric cover 6. For example, when the silicone rubber material 31 is LSR 2670 (a silicone elastomer commercially from Momentive), which is not self-adhesive, a primer (ME153 commercially from Momentive) is applied onto the integral shell, followed by step d).

In step e), the elastomeric cover 6 is exposed under ultraviolet light emitted from an ultraviolet light source (not shown) to modify an outer surface of the elastomeric cover 6 so as to provide a dust-proof effect and enhanced haptic feel for the elastomeric cover 6. The exposure under the ultraviolet light may be performed under the following conditions of: (1) a distance between the elastomeric cover 6 and the ultraviolet light source is 3 mm, (2) illuminance of the ultraviolet light is 210 mW/cm2, and (3) cumulative irradiation energy is 15000 mJ/cm2.

Specifically referring to FIG. 3, in the protective shell unit thus made, the switch button portion 5 is disposed in one of the two minor sidewalls 42, and the simulation pattern portion 7 is disposed in the back wall 41. Alternatively, both of the switch button portion 5 and the simulation pattern portion 7 may be disposed in the back wall 41 via injection molding of the blend of the first plastic material and the phosphorescent pigment in a suitable mold cavity.

In summary, in the process of the disclosure, the switch button portion 5 and the simulation pattern portion 7 having a fluorescent effect are formed via injection molding of the blend of the first plastic material and the phosphorescent pigment in the first mold cavity 10, and the shell body 4 is then formed via injection molding of the second plastic material 21 in the second mold cavity 20 so as to integrally form an integral shell together with the switch button portion 5 and the simulation pattern portion 7. Therefore, the protective shell unit may be formed with fluorescent portions such as the switch button portion 5 and the simulation pattern portion 7 at desirable areas, and the shortcomings encountered in the existing art may be overcome.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A process for making a protective shell unit for a handheld electronic device, the protective shell unit including a shell body and a switch button portion, the shell body including a back wall having two marginal edges opposite to each other in a transverse direction, and two minor sidewalls respectively extending forwardly from the two marginal edges, the switch button portion being disposed in one of the two minor sidewalls, the process comprising steps of:
a) injection molding a blend of a first plastic material and a phosphorescent pigment in a first mold cavity which defines a switch button portion-forming region to obtain the switch button portion; and
b) injection molding a second plastic material in a second mold cavity which defines a shell body-forming region to integrally form the shell body with the switch button portion so as to obtain an integral shell.

2. The process according to claim 1, further comprising:
c) inserting the integral shell into a third mold cavity; and
d) injection molding a silicone rubber material over the integral shell in the third mold cavity to obtain an elastomeric cover which simulates a contour of the integral shell.

3. The process according to claim 1, wherein in step a), a simulation pattern portion which is to be formed in the back wall is obtained in addition to the switch button portion.

4. The process according to claim 1, wherein step a) is performed at a temperature ranging from 70° C. to 110° C.

5. The process according to claim 1, wherein step b) is performed at a temperature ranging from 70° C. to 110° C.

6. The process according to claim 2, wherein step d) is performed at a temperature ranging from 110° C. to 130° C.

7. The process according to claim 1, wherein the first plastic material is selected from the group consisting of polycarbonate, polyethylene, polypropylene, polystyrene, polyurethane, and combinations thereof.

8. The process according to claim 1, wherein the second plastic material is selected from the group consisting of polycarbonate, polyethylene, polypropylene, polystyrene, polyurethane, and combinations thereof.

9. The process according to claim 2, further comprising a step of applying a primer layer onto the integral shell between step c) and step d).

10. A protective shell unit for a handheld electronic device made by the process according to claim 1.
